(19) United States
(12) Patent Application Publication
(10) Pub. No.: US 2006/0106468 A1
(43) Pub. Date: May 18, 2006

(54) Apparatus and method for determining compatibility of a component unit with an electronic machine connected thereto

(75) Inventor: Yong-geun Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/269,856

(22) Filed: Nov. 9, 2005

(30) Foreign Application Priority Data
Nov. 13, 2004 (KR) 10-2004-0092794

(51) Int. Cl. G05B 11/01

(52) U.S. Cl. 700/19; 700/20

(57) ABSTRACT

Provided are an apparatus and method for determining the compatibility of a component unit connected to an electronic machine by storing in the component unit information about electronic machines to which the component unit can be connected, thereby eliminating the need to update firmware of the target electronic machine in order to determine compatibility of newly launched component units. The apparatus has a component unit for storing connectibility information; and a target electronic machine determining the connectibility information to determine whether the component unit can operate when the component unit is connected to the target electronic machine and being driven when it is determined that the component unit can operate.

### BACKGROUND OF THE INVENTION

This application claims the benefit under 35 U.S.C §119(a) of Korean Patent Application No. 10-2004-0092794, filed on Nov. 13, 2004, in the Korean Intellectual Property Office, the entire contents of which are hereby incorporated herein in their entirety by reference.

1. Field of the Invention

The present invention relates to determining the compatibility of a component unit with an electronic machine for connection purposes. more particularly, the present invention relates to an apparatus and method for determining the compatibility of a component unit when connected to an arbitrary electronic machines by storing information about electronic machines to which the component unit can be connected in the component unit.

2. Description of the Related Art

FIG. 1 is a block diagram of a conventional apparatus for determining the compatibility of a component unit (hereinafter, referred to as “conventional apparatus”). The conventional apparatus includes a target electronic machine 100 and a component unit 110.

The target electronic machine 100 is any electronic device, and the component unit 110 is any unit which can be mounted on and/or connected to the target electronic machine 100. The component unit 110 has a unique ID stored therein.

The target electronic machine 100 includes a component name storing unit 120, a controlling unit 130 and a driving unit 140. The controlling unit 130 includes a verifying unit 132 and drive controlling unit 134.

The unique ID of the component unit 110 which can be connected to the target electronic machine 100 and can be properly operated with the target electronic machine 100 is stored in the component name storing unit 120. The verifying unit 132 of the controlling unit 130 reads the unique ID of the component unit 110 from the connected component unit 110 and determines whether the read unique ID is stored in the component name storing unit 120.

When the verifying unit 132 determines that the read unique ID is stored in the component name storing unit 120, the component unit 110 is connected to the target electronic machine 100 and operates properly. Thus, the drive controlling unit 134 instructs the driving unit 140 to drive the target electronic machine 100, and the driving unit 140 drives the target electronic machine 100.

When the conventional apparatus determines the compatibility of the component unit 110, the unique IDs of all component units which can be connected to the target electronic machine 100 and properly operate should be stored in the component name storing unit 120.

Therefore, to determine whether a new component unit is compatible with the target electronic machine 100, unique IDs of newly launched component units which can operate in the target electronic machine 100 should be additionally stored in the component name storing unit 120 from time to time. Such updating of the electronic machine 100 is inconvenient and therefore discourages maintaining the electronic machine for use with future component units. A need exists for a system and method that forestalls an electronic machine becoming obsolete due to incompatibility with newly launched component units.

### SUMMARY OF THE INVENTION

The present invention provides an apparatus and method capable of determining the compatibility of a component unit, comprising an improved or newly launched component unit, connected to an electronic machine without storing information about the improved or newly launched component unit in the electronic machine.

According to an aspect of the present invention, there is provided an apparatus for determining the compatibility of a component unit, the apparatus comprising: a component unit storing connectibility information; and a target electronic machine determining the connectibility information to determine whether the component unit can operate when the component unit is connected to the target electronic machine and being driven when it is determined that the component unit can operate.

In accordance with an exemplary embodiment of the present invention, the target electronic machine may comprise: a controlling unit determining whether the connectibility information comprises information about the target electronic machine to determine whether the component unit can operate when the component unit is connected to the target electronic machine; and a driving unit driving the target electronic machine when it is determined that the connectibility information comprises the information about the target electronic machine.

In accordance with an exemplary embodiment of the present invention, the controlling unit may comprise: a reading unit reading the connectibility information out of the component unit; and a determining unit determining whether the information about the target electronic machine is included in the read connectibility information.

The connectibility information may comprise a plurality of unique Ids, each of the unique Ids representing the target electronic machine which can be operated when the component unit is connected to the target electronic machine.

The unique ID may comprise at least one of a model name, a manufacturing lot number or a manufacturing serial number of the target electronic machine.

According to another aspect of the present invention, there is provided a method of determining the compatibility of a component unit, the method comprising: connecting the component unit, which comprises connectibility information, to a target electronic machine; reading the connectibility information out of the component unit using the target electronic machine; determining whether the read connectibility information comprises information about the target electronic machine using the target electronic machine; and driving the target electronic machine when it is determined that the connectibility information includes the information about the target electronic machine.

The method may further comprise: informing a user that the target electronic machine cannot operate with the component unit when the read connectibility information does not include the information about the target electronic machine.

The connectibility information may comprise a plurality of unique IDs, each of the unique IDs representing the target electronic machine which can be operated when the component unit is connected to the target electronic machine.

According to still another aspect of the present invention, there is provided a computer readable recording medium having embodied thereon a computer program for executing a method of determining the compatibility of a component unit, the program comprising the sets of instructions for: instructing a target electronic machine to which the component unit, which comprises connectibility information, is connected to read the connectibility information from the component unit; instructing the target electronic machine to determine whether the read connectibility information comprises information about the target electronic machine; and driving the target electronic machine when the connectibility information comprises the information about the target electronic machine.

The program may further comprise a set of instructions for instructing the target electronic machine to inform a user that the target electronic machine cannot operate with the component unit when the read connectibility information does not comprise the information about the target electronic machine.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional apparatus for determining the compatibility of a component unit;

FIG. 2 is a block diagram of an apparatus for determining the compatibility of a component unit according to an embodiment of the present invention; and

FIG. 3 is a flowchart illustrating a method of determining the compatibility of a component unit according to an embodiment of the present invention.

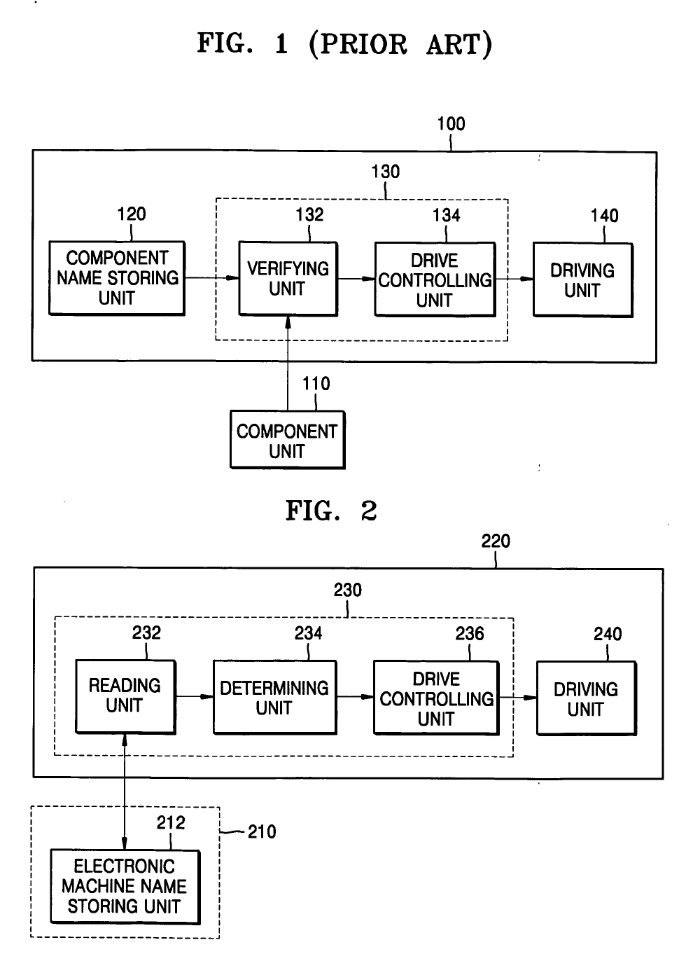

Throughout the drawings, the same or similar elements, features and structures are represented by the same reference numerals.

### DETAILED DESCRIPTION OF THE EXEMPLARY EMBODIMENTS

An apparatus and method of determining the compatibility of a component unit according to the present invention will now be described more fully with reference to the accompanying drawings in which exemplary embodiments of the invention are shown. The present invention may, however, be embodied in many different forms apparent to those skilled in the art and should not be construed as being limited to the embodiments set forth herein.

FIG. 2 is a block diagram of an apparatus for determining the compatibility of a component unit according to an exemplary embodiment of the present invention. The apparatus comprises a target electronic machine 220 and a component unit 210.

The component unit 210 comprises an electronic machine name storing unit 212 in which connectibility information is stored. The connectibility information is information about all electronic machines to which the component unit 210 can be connected, and which can properly operate when the component unit 210 is connected thereto.

The connectibility information may comprise, but is note limited to, a plurality of unique IDs. Herein, the unique ID represents the target electronic machine 220 that can be operated when the component unit 210 is connected to the target electronic machine 220. Hereinafter, the target electronic machine 220 that can be operated when the component unit 210 is connected thereto shall be referred to as the “connectible electronic machine.” Each of the unique IDs may be a model name of each of the connectible electronic machines.

The unique IDs are not limited to the model names of the connectible electronic machines, but can be manufacturing lot numbers or manufacturing serial numbers. Further, each of the unique ID may be a combination of a manufacturing lot number and a manufacturing serial number.

The target electronic machine 220 can operate without being connected to a network, but may also operate when connected to a network as well. The component unit 210 is connected to the target electronic machine 220. The component unit 210 may be mounted on the target electronic machine 220 to be connected.

As an example, the target electronic machine 220 may be an image forming apparatus such as a printer, and the component unit 210 may be a cartridge to be installed in the printer. That is, the electronic machine name storing unit 212 of the cartridge 210 stores information about every printer for which the cartridge 210 can properly operate when the cartridge 210 is installed therein.

The target electronic machine 220 comprises a controlling unit 230 and a driving unit 240. The controlling unit 230 comprises a reading unit 232, a determining unit 234, and a drive controlling unit 236.

The reading unit 232 of the controlling unit 230 reads the connectibility information from the electronic machine name storing unit 212 of the component unit 210 connected to the electronic machine 220.

The determining unit 234 of the controlling unit 230 determines whether information about the target electronic machine 220 is present in the connectible information read by the reading unit 232. The information about the target electronic machine 220 may comprise the unique ID of the target electronic machine 220. The unique ID is preferably a model name of the target electronic machine 220, but may also be a manufacturing lot number of the target electronic machine 220, manufacturing serial number of the target electronic machine 220, or a combination of the manufacturing lot number and the manufacturing serial number of the target electronic machine 220.

When the determining unit 234 determines that the information about the target electronic machine 220 is not included in the read connectibility information, the drive controlling unit 236 may inform a user that the target electronic machine 220 cannot operate with the component unit 210 through a user display unit (not shown) or an audio device which is provided with the target electronic machine 220.

On the other hand, when the determining unit 234 determines that the information about the target electronic machine 220 is included in the read connectibility information, the drive controlling unit 236 of the controlling unit 230 instructs the driving unit 240 to drive the target electronic machine 220, and the driving unit 240 drives the target electronic machine 220.

For example, when the target electronic machine 220 is a printer, the component unit 210 is a cartridge and the electronic machine name storing unit 212 of the cartridge 210 stores unique IDs of a printer A and a printer B, the connectibility information read by the reading unit 232 comprises unique IDs of the printer A and the printer B. Therefore, if the cartridge 210 is connected to a printer C, the determining unit 234 determines that the connected cartridge 210 cannot operate in the printer C, and the target electronic machine 220 may inform a user that the printer C cannot operate.

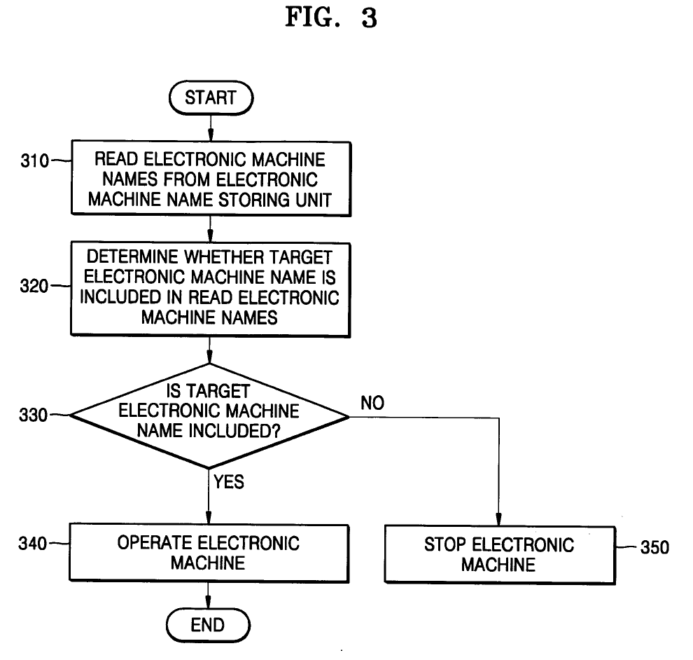

FIG. 3 is a flowchart illustrating a method of determining the compatibility of a component unit according to an embodiment of the present invention. The method illustrated in FIG. 3 will be described with reference to the apparatus illustrated in FIG. 2.

Referring to FIG. 3, the reading unit 232 of the target electronic machine 220 reads connectibility information from the electronic machine name storing unit 212 of the component unit 210 which is connected to the target electronic machine 220 (operation 310).

The determining unit 234 of the target electronic machine 220 determines whether information about the target electronic machine 220 is present in the read connectibility information (operation 320). When information about the target electronic machine 220 is present in the connectibility information, the newly connected component unit is compatible with the target electronic machine 220 and can properly operate. Accordingly, the driving unit 240 drives the target electronic machine 220 (operation 340). For example, the drive controlling unit 236 instructs the driving unit 240 to drive the target electronic machine 220.

However, when the determining unit 234 determines that the connectibility information does not comprise information about the target electronic machine 220, the target electronic machine 220 informs the user that the target electronic machine 220 cannot operate and stops (operation 350). The fact that information about the target electronic machine is not present in the connectibility information indicates that the connected component unit 210 cannot properly operate with the target electronic machine 220.

As described above, according to the present invention, in an apparatus and method for determining the compatibility of a component unit, a target electronic machine reads connectibility information stored in a component unit and determines compatibility, and thus does not need to store information about all component units which can properly operate with the target electronic machine. Further, there is no need to update firmware of the target electronic machine in order to determine the compatibility of newly launched component units.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for determining the compatibility of a component unit, the apparatus comprising:
a component unit storing connectibility information; and
a target electronic machine determining the connectibility information to determine whether the component unit can operate when the component unit is connected to the target electronic machine and being driven when it is determined that the component unit can operate.

2. The apparatus of claim 1, wherein the target electronic machine comprises:
a controlling unit determining whether the connectibility information comprises information about the target electronic machine to determine whether the component unit can operate when the component unit is connected to the target electronic machine; and
a driving unit driving the target electronic machine when it is determined that the connectibility information comprises the information about the target electronic machine.

3. The apparatus of claim 2, wherein the controlling unit comprises:
a reading unit reading the connectibility information out of the component unit; and
a determining unit determining whether the information about the target electronic machine is included in the read connectibility information.

4. The apparatus of claim 1, wherein the connectibility information comprises a plurality of unique IDs, each of the unique IDs representing the target electronic machine which can be operated when the component unit is connected to the target electronic machine.

5. The apparatus of claim 4, wherein the unique ID comprises at least one of a model name, a manufacturing lot number or a manufacturing serial number of the target electronic machine.

6. A method of determining the compatibility of a component unit, the method comprising:
connecting the component unit, which comprises connectibility information, to a target electronic machine;
reading the connectibility information out of the component unit using the target electronic machine;
determining whether the read connectibility information comprises information about the target electronic machine using the target electronic machine; and
driving the target electronic machine when it is determined that the connectibility information comprises the information about the target electronic machine.

7. The method of claim 6, further comprising:
informing a user that the target electronic machine cannot operate with the component unit when the read connectibility information does not comprise the information about the target electronic machine.

8. The method of claim 6, wherein the connectibility information comprises a plurality of unique IDs stored, each of the unique IDs representing the target electronic machine which can be operated when the component unit is connected to the target electronic machine.

9. A computer readable recording medium having embodied thereon a computer program for executing a method of determining the compatibility of a component unit, the program comprising the processes of:
instructing a target electronic machine to which the component unit, which comprises connectibility information, is connected to read the connectibility information from the component unit;
instructing the target electronic machine to determine whether the read connectibility information comprises information about the target electronic machine; and
driving the target electronic machine when the connectibility information comprises the information about the target electronic machine.

10. The computer readable recording medium of claim 9, wherein the program further comprises the process of instructing the target electronic machine to inform a user that the target electronic machine cannot operate with the component unit when the read connectibility information does not comprise the information about the target electronic machine.
